(19) United States
(12) Patent Application Publication
(10) Pub. No.: US 2009/0130279 A1
(43) Pub. Date: May 21, 2009

(54) Method and Apparatus for Smokeless Cooking

(75) Inventor: Gary W. Price, Guntersville, AL (US)

Correspondence Address: LANIER FORD SHAVER & PAYNE P.C., P O BOX 2087, HUNTSVILLE, AL, 35804-2087, US

(73) Assignee: PRICELESS COOKING SYSTEMS, LLC, Huntsville, AL (US)

(21) Appl. No.: 11/942,428

(22) Filed: Nov. 19, 2007

(51) Int. Cl. A47J 27/04; A23L 1/00

(52) U.S. Cl. 426/510; 99/447

(57) ABSTRACT

A method and apparatus for smokeless cooking of food is claimed. An enclosed cooking chamber with substantially concave walls is provided. A food item is enclosed within the cooking chamber and a heating element is activated to provide direct heat within the chamber. A seasoning compartment beneath the chamber generates moisture which is delivered to the cooking chamber via a tapered duct to increase the volume of moisture to the food.

### FIELD OF THE INVENTION

The invention provides a method and apparatus for cooking food in a smokeless cooker. Specifically, the invention provides for the cooking of food by applying a combination of direct heat and moisture to the food within an enclosed chamber.

### BACKGROUND OF THE INVENTION

Traditional outdoor smokers and grills are usually heated by either compressed gas or charcoal, and have the drawback of producing substantial amounts of smoke, and even flames. Apartment dwellers are generally not permitted to use traditional grills or smokers on their outdoor decks due to potential safety hazards. It would be desirable to have a cooker that imparts to meat the same smoky moist flavor as a smoker but without the actual smoke.

### SUMMARY OF THE INVENTION

The present invention achieves this objective by providing an electric smokeless cooker that cooks food by a combination of direct heat and flavored moisture. The cooker comprises a substantially enclosed cooking chamber with concavely curved walls. A heating element is disposed within the cooking chamber to apply direct heat to food items within the chamber. A seasoning compartment disposed beneath the cooking chamber generates flavored moisture which is directed to the cooking chamber through a tapered duct.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements.

FIG. 1 is a diagram of one embodiment of the invention according to the present disclosure.

FIG. 2 is a left side view of one embodiment of the invention according to the present disclosure.

FIG. 3 depicts a rear view of the embodiment of the invention illustrated in FIG. 2.

FIG. 4 depicts a left side view of one embodiment of the moistureduct according to the present disclosure.

FIG. 5 depicts a perspective view of the moistureduct illustrated in FIG. 4.

FIG. 6 is a flow chart illustrating exemplary functionality of a cooker according to the present disclosure.

FIG. 7 is a flow chart illustrating exemplary functionality of a cooker according to the present disclosure.

### DETAILED DESCRIPTION

The present invention and its advantages are best understood by referring to the drawings. The elements of the drawings are not necessarily to scale, emphasis instead being placed upon clearly illustrating the principles of the invention.

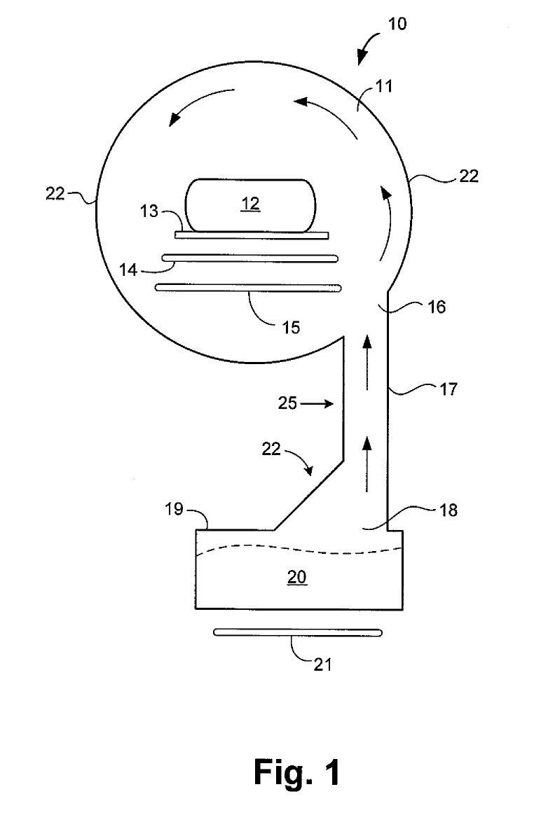

FIG. 1 is a diagram of one embodiment of a cooker 10 according to the present disclosure. In this embodiment, a substantially enclosed cooking chamber 11 with concavely curved walls 22 contains a food item 12 disposed on a rack 13. A drip pan 14 underneath the rack 13 contains drippings (not illustrated) from the food item 12. A heating element 15 provides direct heat for heating the cooking chamber 11. In one embodiment, the heating element 15 is an electric resistance tubular heating element such as a Calrod® element.

Seasoning compartment 19 is connected to cooking chamber 11 via moisture duct 17. Seasoning compartment 19 is disposed at an elevation beneath the cooking chamber 11. Although the embodiment illustrated in FIG. 1 shows the seasoning compartment 19 as being disposed directly beneath the cooking chamber 11, the seasoning compartment 19 may be located in any convenient orientation relative to the cooking chamber 11 provided that the elevation of the seasoning compartment 19 is lower than that of the cooking chamber 11 so that rising moisture (not illustrated) will readily enter the cooking chamber 11 from the seasoning compartment 19.

Duct 17 has an upper portion 25 with an upper end 16 connected to cooking chamber 11 and a lower portion 22 with a lower end 18 connected to seasoning compartment 19. Lower portion 22 is flared toward its lower end 18 in order to maximize the volume of moisture delivered from the seasoning compartment 19 to the cooking chamber 11.

Burner 21 beneath seasoning compartment 19 heats liquid 20 in seasoning compartment 19 thereby creating moisture. Liquid 20 may be water, and seasonings such as wood chips, liquid seasoning, dry seasoning, or flavoring pellets (not illustrated) may be added to the liquid to infuse flavor into food item 12. Burner 21 may be any suitable type of stove or oven burner known in the art or future-developed.

In operation, a user (not illustrated) places food item 12 on rack 13 in cooking chamber 11. The cooker 10 has a door (not illustrated) that allows access to the interior of chamber 11. The user verifies that seasoning compartment 19 contains sufficient liquid 20 to generate moisture. If desired, the user may add flavorings to the liquid 20. The user applies power to the cooker 10, which causes heating element 15 and burner 21 to begin heating. Heating element 15 causes immediate direct heating within cooking chamber 11 and begins to cook the food, which forces some of the moisture from the food. Burner 21 eventually heats the liquid 20 sufficiently to cause the liquid 20 to boil and generate moisture, for example, steam. Typically, the moisture generation begins 15-30 minutes after the cooker 10 is powered on. This time delay between the heating of cooking chamber 11 by heating element 15 and the moisture generation is further discussed below.

The moisture (not illustrated) rises from the seasoning compartment 19 into duct 17 and then into cooking chamber 11. The tapered lower portion 18 of the duct 17 forces the moisture to concentrate in duct 17, delivering a higher volume of moisture to the cooking chamber 11. The concave walls 22 of the chamber 11 cause the moisture to rotate around the chamber 22 and surround and infuse the food item 12 with moisture. The food item 12 has been made ready to accept moisture because it has been “pre-cooked” by the heating element 15, which has forced some of the moisture from the food item. The timing of this pre-cooking by the heating element 15 followed by the moisture infusion after steam generation begins causes the food item to be moist and succulent when fully cooked.

The ideal temperature in cooking chamber 11 for cooking most food items is 285 degrees Fahrenheit, and a range from 230 to 325 degrees Fahrenheit is considered acceptable in one embodiment of the invention. Using a 240 Volt electric resistance tubular heating element as heating element 15 and powering it to half power (120 Volts) provides the ideal cooking environment within the cooking chamber to drive some moisture out of the food item without drying it out or overcooking it and preparing it to accept infused moisture from the moisture.

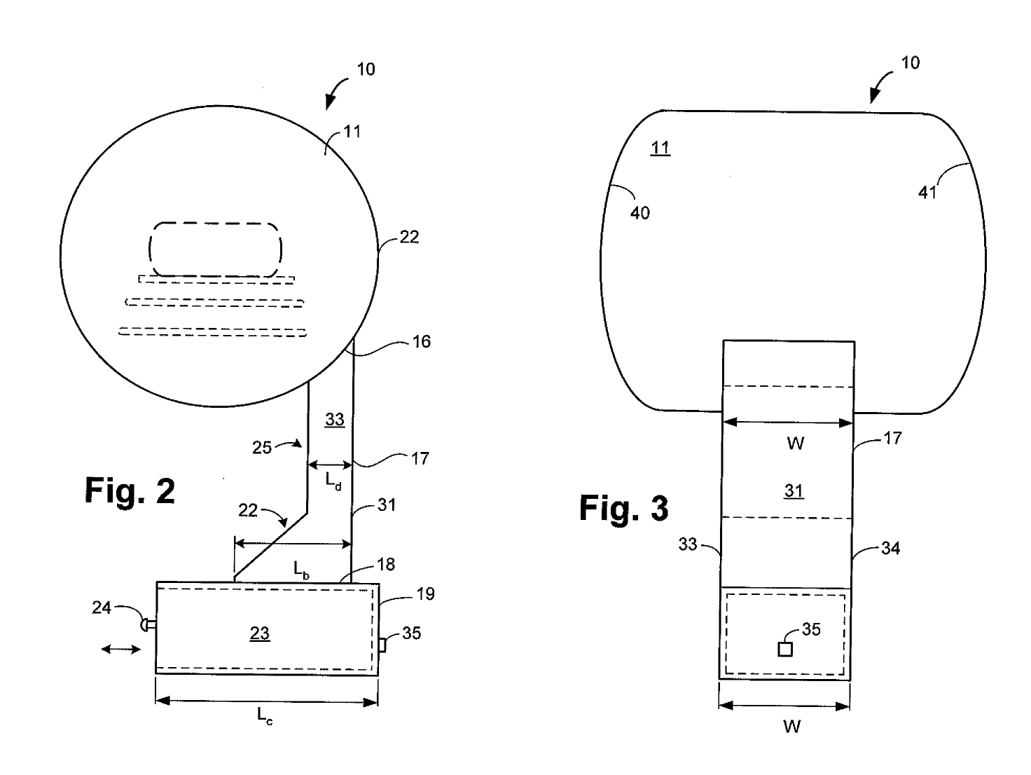

FIG. 2 illustrates a left side plan view of one embodiment of the cooker 10. Cooking chamber 11 is connected to seasoning compartment 19 via duct 17. Seasoning compartment 19 encloses drawer 23 which contains liquid 20 (FIG. 1). Handle 24 opens and closes drawer 23 to allow a user (not illustrated) to access seasoning compartment 19 for adding liquid, seasonings, and the like (not illustrated). Drawer 23 may be removed from seasoning compartment 19 for cleaning.

As shown in FIG. 2, duct 17 comprises an upper portion 25 comprising upper end 16, wherein the upper portion 25 has a uniform length “L_{d}.” The duct 17 further comprises a lower portion 22 that tapers on the front side to lower end 18. Lower end 18 has a length “L_{b}” that is wider than the length L_{d} of the upper portion 25, due to the tapering of the lower portion 22. Seasoning compartment 19 has a length, “L_{c},” which in the illustrated embodiment is longer than the length of the lower end 18.

FIG. 3 illustrates a rear view of the embodiment of the cooker 10 illustrated in FIG. 2. End walls 40 and 41 are concave to promote circulation of moisture (not illustrated) within the cooking chamber 11. In this embodiment, duct 17 has a width “W” substantially equal to the width of the seasoning compartment 19. Having such a wide duct 17 causes a large volume of moisture to be delivered from the seasoning compartment 19 to the cooking chamber 11.

In one embodiment of the invention, the cooking chamber 11 is approximately 16 inches in diameter by 24 inches wide, with a cylindrical shape and concave ends. In this embodiment of the invention, L_{d} (FIG. 2) is approximately 3.125 inches in length, L_{b} (FIG. 2) is approximately 7 inches in length, W (FIG. 3) is approximately 7.625 inches in width, and the length of seasoning compartment 19, “L_{c}” (FIG. 2), is 16.75 inches. Thus, in this embodiment, the length L_{b} and width W of duct 17 at its lower end 18 are more than twice the length L_{d} at its upper portion 22. This configuration maximizes the volume of moisture delivered by duct 17 to cooking chamber 11.

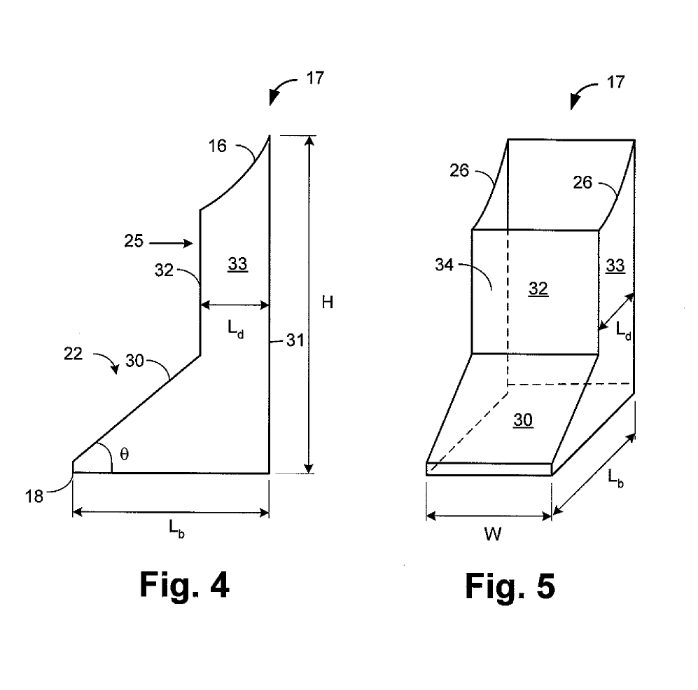

An enlarged side view of one embodiment of duct 17 is illustrated in FIG. 4, and a perspective view of duct 17 is shown in FIG. 5. As shown in FIG. 4, front upper plate 32 of duct 17 is generally vertical, and front lower plate 30 of duct 17 is disposed at an angle “0” to the horizontal plane. In one embodiment of the invention, angle θ is between 40 and 50 degrees, though other suitable angles may be utilized to provide the desired tapering of the front edge 30 of duct 17.

As shown in FIG. 5, left side 33 and right side 34 of duct 17 are substantially flat and substantially vertical, as is rear side 31 (FIG. 4). Left side 33 and right side 34 of duct 17 are curved on their upper side edges 26 to align with and be joined with the curved walls 22 (FIG. 2) of cooking chamber 11. Duct 17 is typically joined with cooking chamber 11 and seasoning compartment 19 via welds (not illustrated). In one embodiment of the invention, the height “H” of duct 17 is approximately 15.5 inches, though other dimensions may be utilized without departing from the scope of the present invention.

The cooker 10 includes fail safe features to shut the power off to the cooker if the liquid evaporates from the seasoning chamber, which would cause the seasoning compartment 19 to exceed a predetermined temperature. In one embodiment of the invention, thermocouple 35 (FIG. 3) attached to seasoning compartment 19 reads the temperature on the outside surface of the compartment 19. If this temperature exceeds approximately 300-325 degrees Fahrenheit, thermocouple 35 closes a relay (not illustrated), shutting off power to cooker 10. Cooker 10 also has a timer (not illustrated), that can be set by the user to turn power to cooker 10 off in a desired timeframe.

The cooker may be fabricated from any number of heat-resistant materials, such as stainless steel, galvanized steel, galvaneal, ceramic, aluminum or composite materials.

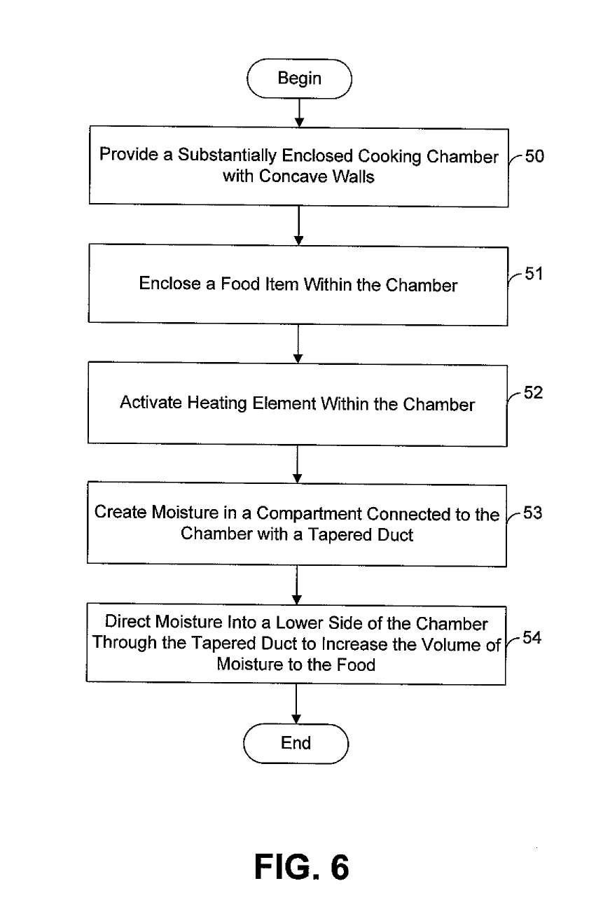

FIG. 6 illustrates one method for cooking food 12 (FIG. 1) with the cooker 10 (FIG. 1) according to one exemplary embodiment of the invention. Referring to step 50, a substantially enclosed cooking chamber 11 with concave walls is provided. A food item 12 is enclosed within cooking chamber 11, in accordance with step 51. Per step 52, the heating element 15 within cooking chamber 11 is activated to begin cooking of food item 12. Referring to step 53, moisture is created in seasoning compartment 19 (FIG. 1), which is connected to cooking chamber 11 via tapered duct 17. As shown in step 54, moisture is then directed into a lower side of cooking chamber 11 through the tapered duct to increase the volume of moisture delivered to food item 12.

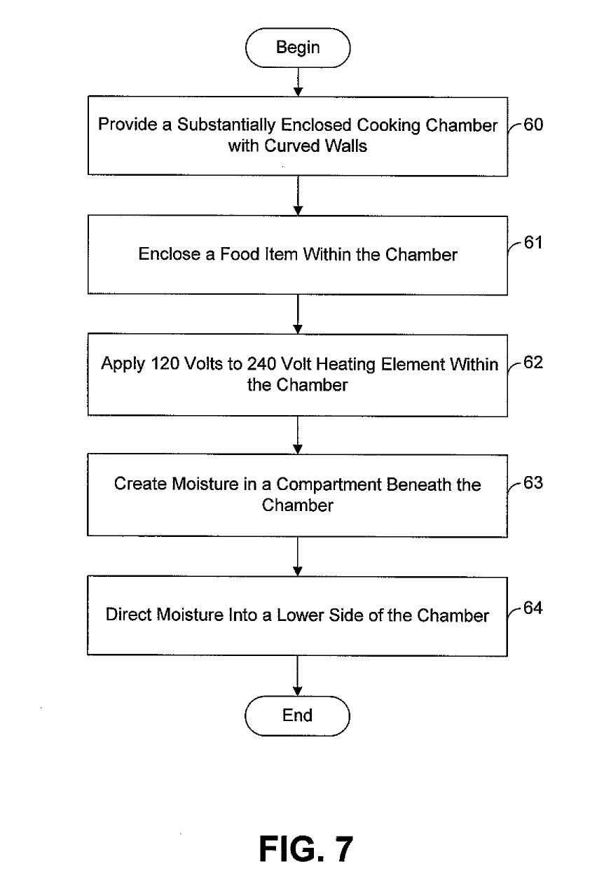

FIG. 7 illustrates another method for cooking food 12 (FIG. 1) with the cooker 10 (FIG. 1) according to one exemplary embodiment of the invention. Referring to step 60, a substantially enclosed cooking chamber 11 with curved walls is provided. A food item 12 is enclosed within cooking chamber 11, in accordance with step 61. Per step 62, a 240 Volt heating element 15 (FIG. 1) within cooking chamber 11 is powered with 120 Volts of electricity to begin cooking of food item 12. Referring to step 63, moisture is created in seasoning compartment 19 (FIG. 1), which is disposed beneath cooking chamber 11. As shown in step 64, moisture is then directed into a lower side of cooking chamber 11.

This invention may be provided in other specific forms and embodiments without departing from the essential characteristics as described herein. The embodiment described is to be considered in all aspects as illustrative only and not restrictive in any manner.

As described above and shown in the associated drawings and exhibits, the present invention comprises smokeless cooker. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A method for cooking food comprising the steps of:
a. providing a substantially enclosed cooking chamber;
b. enclosing a food item within the chamber;
c. applying voltage to a heating element within the chamber to heat the chamber;
d. creating steam in a compartment, wherein the compartment is connected to the chamber through a tapered duct;
e. directing steam into the chamber trough the tapered duct, wherein the tapered duct increases the volume of steam directed into the chamber.

2. The method of claim 1, wherein the heating element is an electric resistance tubular heating element.

3. The method of claim 2, wherein the heating element is a 240 volt element and the voltage applied is 120 volts.

4. The method of claim 1, wherein the cooking chamber has substantially concave walls.

5. The method of claim 1, wherein the tapered duct connects to a lower portion of the chamber.

6. The method of claim 1, wherein a width of the seasoning compartment is substantially equal to a width of the duct.

7. A method for cooking food comprising the steps of:
a. providing a substantially enclosed cooking chamber;
b. enclosing a food item within the chamber;
c. apply 120 volts of electricity to an electric resistance tubular heating element within the chamber to heat the chamber;
d. creating steam in a compartment beneath the chamber;
e. directing steam into a lower side of the chamber.

8. A device for cooking food, comprising:
a substantially enclosed cooking chamber;
a heating element within the cooking chamber;
a seasoning compartment beneath the cooking chamber, wherein the seasoning compartment generates steam;
a duct connecting the seasoning compartment with the cooking chamber, wherein the duct is tapered.

9. The device of claim 8, wherein cooking chamber has substantially concave walls.

10. The device of claim 8, wherein the heating element is a 240 volt electric resistance tubular heating element.

11. The device of claim 8, wherein the length and width of the bottom end of the duct are more than twice the length of the top end of the duct.

12. The device of claim 8, wherein a first end of the duct connects to the compartment and a second end connects to the chamber.

13. The device of claim 12, wherein the second end is narrower than the first end.
